(19) United States
(12) Patent Application Publication
(10) Pub. No.: US 2012/0159568 A1
(43) Pub. Date: Jun. 21, 2012

(54) Method and Apparatus for Limiting Digital Content Consumption Inside Defined Real-world Geographic Area(s)

(76) Inventor: Haixiang He, San Mateo, CA (US)

(21) Appl. No.: 13/327,235

(22) Filed: Dec. 15, 2011

Related U.S. Application Data
(60) Provisional application No. 61/424,519, filed on Dec. 17, 2010.

(51) Int. Cl. G06F 21/00

(52) U.S. Cl. 726/1

(57) ABSTRACT

A method for limiting digital content consumption inside defined real-world geographic area(s) is disclosed. In one embodiment, the method is realized by adding additional consumption policy for geographic control to digital content's metadata, requesting the digital consumption device to acquire and provide its current location, checking device's current location against the geographic control consumption policy, and displaying the content for consumption if the digital content consumption policy is satisfied.

### CROSS-REFERENCE TO RELATED APPLICATIONS

This patent application claims priority to U.S. Provisional Patent Application No. 61/424519, entitled “Method and Apparatus for Limiting Digital Content Consumption Inside Defined Real-world Geographic Area(s)”, filed on Dec. 17, 2010 and naming Haixiang He as inventor, the disclosure of which is hereby incorporated herein, in its entirety, by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of digital content consumption. More particularly, the present invention is in the technical field of limiting digital content consumption inside defined real-world geographic area(s).

### BACKGROUND OF THE INVENTION

Digital content consumption requires a hardware platform and software applications that are primarily used for receiving and viewing digital content. Common examples of digital content include music, video games, films, books, and software.

Technologies including Digital Right Management (DRM) have been developed to enable content owners or distributors to control their digital content consumption. Most existing technologies focus on preventing unauthorized consumption.

Currently there is no efficient or easy way to control the digital content consumption inside defined real-world geographic area(s), while on the other hand physical content consumption can be easily controlled inside defined real-world geographic area(s). For example, a specific print book can be freely read inside a particular physical bookstore. But currently an eBook cannot be freely read at the same particular physical bookstore.

However, there are many use cases and motivations to control digital content distribution inside defined real-world geographic area(s). For example, many people may want to freely read eBooks inside a bookstore similar to current experience of freely reading print books. And hence, such a control method and apparatus is desired.

### SUMMARY OF THE INVENTION

The present invention is a method and apparatus to control the digital content consumption. It provides a capability for digital content to be consumed inside certain defined real-world geographic area(s).

These geographic areas can be a predefined set of boundaries like coffee shop, bookstore, school attendance zones or neighborhood boundaries. They can also be dynamically generated as in a radius around a store or point location and/or as in any customized shape.

Information representing the defined real-world geographic area(s) is associated with each piece of digital content. The association can be achieved for example by adding the information to the digital content's metadata.

The digital content consumption device needs have the capability to acquire its current location. The current location may be in the format of a pair of data (latitude, longitude). The location can be acquired through Global Position System (GPS) or other location acquisition systems and services.

Function or capability to limit digital content consumption inside defined real-world geographic area(s) can be added to digital content consumption hardware platform and software applications. When digital content is consumed, the consumption hardware and software need to acquire the current location. If the current location is inside the defined real-world geographic area(s), the consumption is allowed. Otherwise, the content consumption is prohibited.

Those skilled in the art will appreciate the scope of the present invention and realize additional aspects thereof after reading the following detailed description of the preferred embodiments in association with the accompanying figures.

### BRIEF DESCRIPTION OF THE DRAWINGS

The present invention is illustrated by way of example in the following drawings in which like references indicated similar elements. The following drawings disclose various embodiments of the present invention for purposes of illustration only and are not intended to limit the scope of the invention. For purposes of clarity, not every component may be labeled in very figure. In the figures:

FIG. 1 is a functional block diagram of a digital content consumption device according to an embodiment of the present invention;

FIG. 2 is a functional block diagram of a digital content storage according to an embodiment of the present invention;

FIG. 3 shows a real-world geographic area dynamically generated as in a radius around a location point according to an embodiment of the present invention;

FIG. 4 shows a real-world geographic area dynamically generated as in a polygon according to an embodiment of the present invention; and

FIG. 5 is a flow diagram of a process of consuming a piece of digital content according to an embodiment of the present invention.

### DETAILED DESCRIPTION OF THE INVENTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

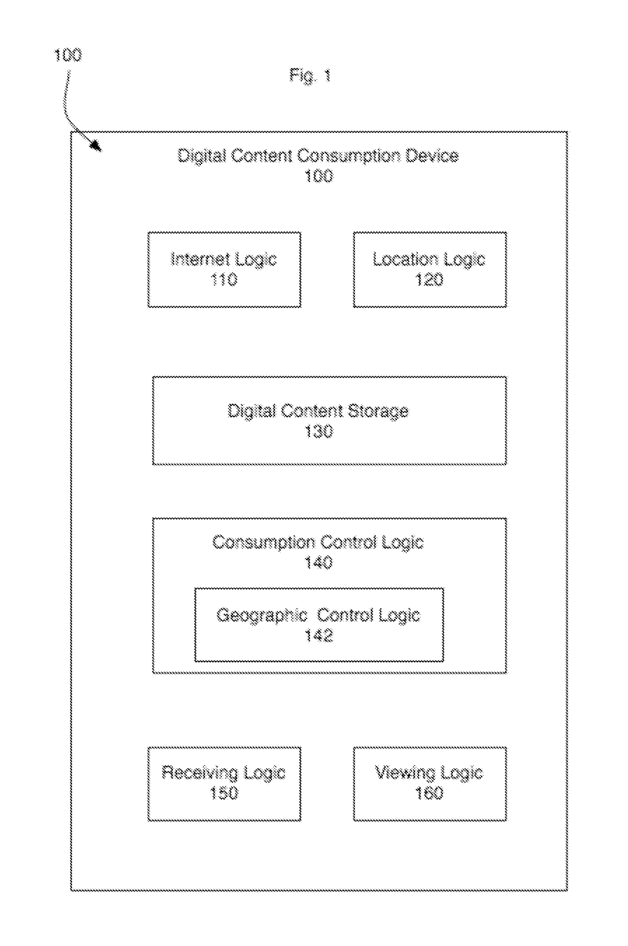

FIG. 1 is a functional block diagram showing the relevant components of an example digital content consumption device 100 that may be used to consume digital content. Digital content consumption device has hardware platform and software applications. In the embodiment shown in FIG. 1, the digital content consumption device 100 includes an Internet logic 110 configured to enable the Internet especially mobile Internet communication. It also includes location logic 120 configured to enable the digital content consumption device to acquire its current location. The location can be specified in a pair of data (latitude, longitude) format.

In the embodiment shown in FIG. 1, the digital content is stored in digital content storage 130. The digital content consumption device 100 contains a receiving logic 150 configured to receive digital content through Internet logic 110 from external entities. Upon receipt of digital content, the receiving logic 150 will store the digital content in digital content storage 130. The digital content consumption device 100 also contains a viewing logic 160 configured to view digital content. The viewing logic 160 will get the digital content from digital content storage 130 and display it for content consumption. In another embodiment of the present invention, the digital content storage 130 may reside outside the device and connect over Internet especially mobile Internet with digital content consumption device 100 through Internet logic 110.

In the embodiment shown in FIG. 1, the digital content consumption device 100 includes a consumption control logic 140 configured to enforce consumption control policy. The consumption control logic 140 contains a geographic control logic 142 configured to enforce the control policy to limit digital content consumption inside defined real-world geographic area(s). The device's current location acquired through location logic 120 will be used by geographic control logic 142 for policy enforcement. Consumption control logic 140 and geographic control logic 142 may reside outside the digital content consumption device 100 in another embodiment of the present invention. The policy enforcement can be achieved through client-server solution.

Digital content consumption device 100 may also contain other components.

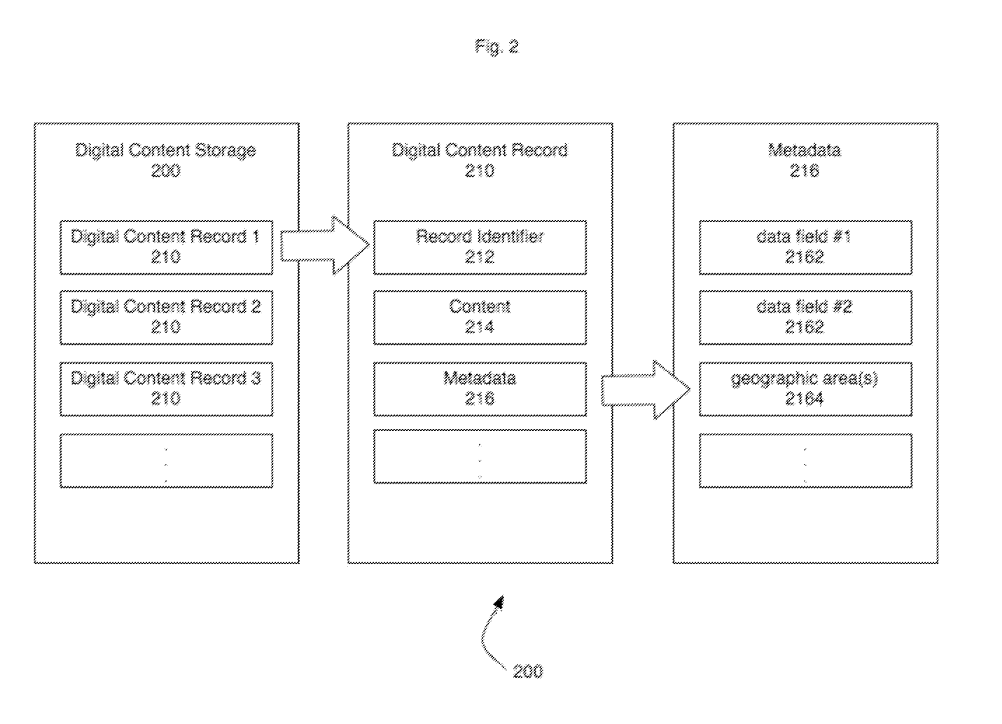

FIG. 2 is a functional block diagram showing the relevant components of an example digital content storage 200 that may be used to store digital content. Digital content database can be any hardware or software that is capable of storing digital content. In the embodiment shown in FIG. 2, the digital content storage 200 includes a number of digital content records 210 configured to store each piece of digital content. Digital content record 210 includes record identifier 212 configured to uniquely identify each piece of digital content, content 214 configured to store the real content part of the digital content record 210, and metadata 216 configured to store information related to the digital content. Digital content record 210 may also contain other fields. Metadata 216 includes a number of data fields 2162 configured to store metadata information related to the corresponding digital content. One data field 2162 is geographic area(s) 2164 configured to store defined real-world geographic area(s). Digital content can be any type of digital content including digital music, digital video, eBook, etc., according to an embodiment of the present invention.

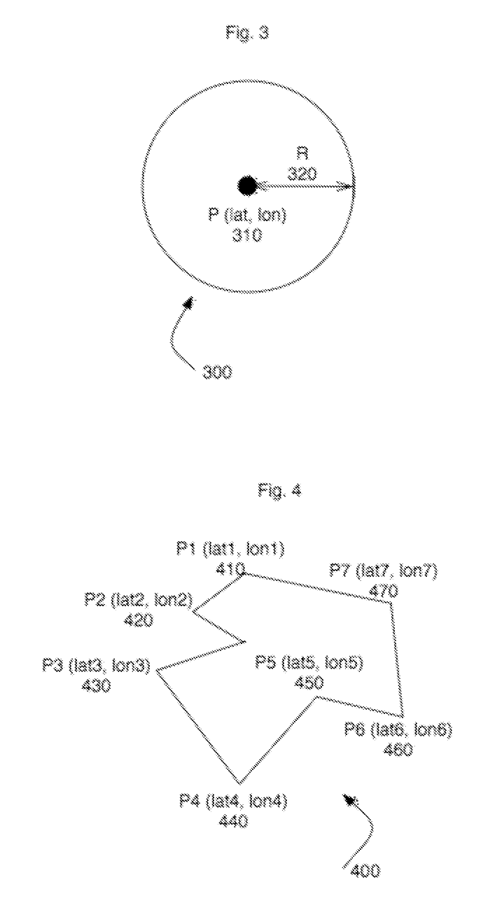

FIG. 3 shows a geographic area dynamically generated as in a radius around a location point according to an embodiment of the present invention. In the embodiment shown in FIG. 3, the geographic area(s) 300 is dynamically generated as in a radius R 320 around a location point P 310. Location point P 310 represents a real-world location point with latitude lat and longitude lon.

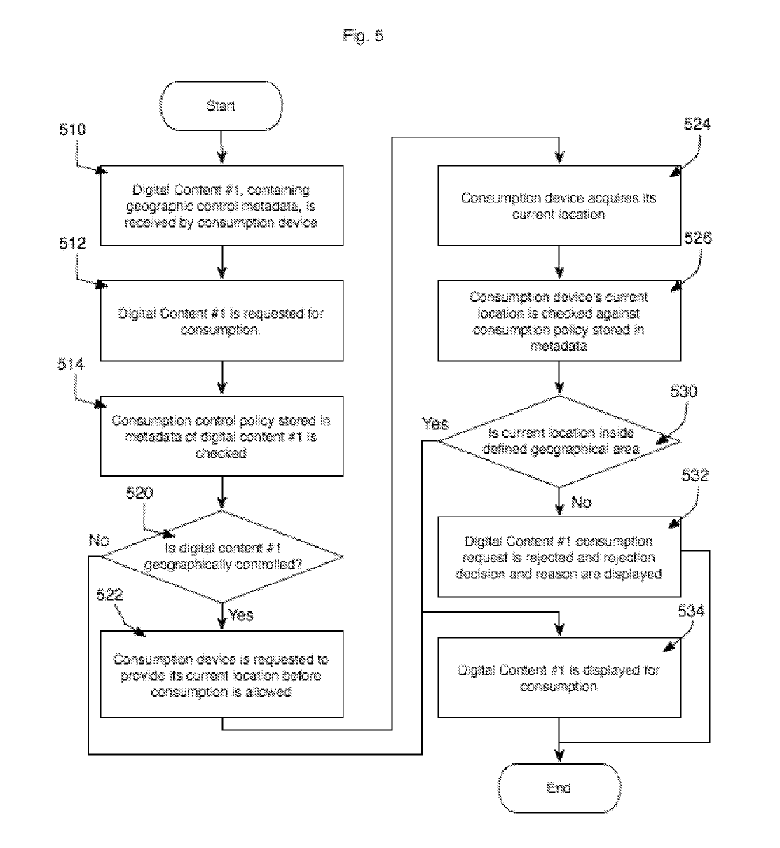

FIG. 4 shows a geographic area dynamically generated as in a polygon according to an embodiment of the present invention. In the embodiment shown in FIG. 4, the geographic area 400 is dynamically generated as in a polygon. The polygon is specified by locations points P1 410 representing a real-world location point with latitude latl and longitude lonl; P2 420 representing a real-world location point with latitude lat2 and longitude lon2; P3 430 representing a real-world location point with latitude lat3 and longitude lon3; P4 440 representing a real-world location point with latitude lat4 and longitude lon4; P5 450 representing a real-world location point with latitude lat5 and longitude lon5; P6 460 representing a real-world location point with latitude lath and longitude lon6; and P7 470 representing a real-world location point with latitude lat7 and longitude lon7.

FIG. 5 is a flow diagram of a process for consuming a piece of digital content with consumption policy to control the consumption inside defined real-world geographic area(s) according to an embodiment of the invention. While particular messages may be described in connection with FIG. 5, the invention is not limited to this particular sequence of message as other sequences may be used as well. Also, the messages in the following description have been given particular names for ease of reference. The names of the messages may change without departing from the scope of the invention.

As shown in FIG. 5, before it can be consumed, digital content #1 needs to be received by the digital content consumption device (510). Digital content #1 is stored as digital content record #1 210 in the digital content storage 200. It contains metadata 216, which includes geographic area(s) 2164. The geographic area 2164 for digital content #1 is defined as in a radius around a location point 300.

When digital content #1 is requested for consumption (512), consumption control policy stored in metadata 216 is checked (514) by consumption control logic 140, more specifically the geographic control logic 142. If the metadata does not contain the policy to control the content consumption geographically (520), then the digital content #1 is displayed for consumption (534). Otherwise (520), the consumption device is requested to provide its current location (522).

Consumption device acquires its current location by way of location logic 120 (524) in latitude and longitude format. Consumption control logic 140, more specifically the geographic control logic 142, will check device's current location against the consumption control policy store in metadata 216, more specifically geographic area(s) 2164 (526).

If consumption device's current location is not inside the defined geographical area(s) (530), the digital content #1 consumption request is rejected and rejection decision and reason are displayed (532). Otherwise (530), the digital content #1 is displayed for consumption (534).

In another embodiment of the present invention, the consumption control logic 140 and geographic control logic 142 may be implemented outside digital content consumption device 100. In such a client-server situation, additional hardware and software may be required. And additional sequence may be required also.

It should be understood that all functional statements made herein describing the functions to be performed by the methods of the invention may be performed by software programs implemented utilizing subroutines and other programming techniques known to those of ordinary skill in the art. Alternatively, these functions may be implemented in hardware, firmware, or a combination of hardware, software, and firmware. The invention is thus not limited to a particular implementation.

The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of limiting digital content consumption inside defined real-world geographic areas, the method comprising the steps of:
associating a content consumption control policy with a content record;
acquiring a current location of a content consumption device; and
determining a consumption of the content record based on the content consumption control policy and the current location of the content consumption device for consuming the content record on the content consumption device.

2. The method as claimed in claim 1, wherein the consumption control policy has one or a plurality of the real-world geographic areas.

3. The method as claimed in claim 2, wherein the real-world geographic area is defined at least as one of the specifications as a pre-defined boundary for a point of interest, a radius around a point of interest, and a customized polygon shape around a point of interest.

4. The method as claimed in claim 1, further comprising sending the content record having the control policy for controlling a consumption of the content record on the content consumption device.

5. The method as claimed in claim 1, wherein the current location is acquired through one or a plurality of methods of using Global Position System (GPS) or other location acquisition systems and services.

6. The method as claimed in claim 5, further comprising specifying the current location in a pair of data (latitude, longitude) format

7. The method as claimed in claim 1, wherein determining the consumption of the content record comprises checking the current location of the content consumption device against the content consumption control policy based on the defined real-world geographic areas.

8. The method as claimed in claim 7, further comprising allowing the consumption of the content record based on the current location being inside the defined real-world geographic areas.

9. The method as claimed in claim 7, further comprising prohibiting the consumption of the content record based on the current location being outside the defined real-world geographic areas.

10. A system for limiting digital content consumption inside defined real-world geographic areas comprising:
a storage system for storing a content record;
a content management logic for associating a content consumption control policy with the content record;
a communication logic for sending the content record having the control policy;
a location logic for acquiring a current location of a content consumption device; and
a consumption control logic for determining a consumption of the content record on the content consumption device.

11. The system as claimed in claim 10, wherein the content consumption control policy is specified as one or a plurality of the real-world geographic areas.

12. The system as claimed in claim 11, wherein the real-world geographic areas are defined at least as one of the descriptions as a pre-defined boundary for a point of interest, a radius around a point of interest, and a customized polygon shape around a point of interest.

13. The system as claimed in claim 10, wherein the consumption control logic includes a geographic control logic that checks the current location of the content consumption device against the content consumption control policy.

14. The system as claimed in claim 13, wherein the geographic control logic determines allowing the consumption of the content record based on the current location being inside the geographic area.

15. The system as claimed in claim 13, wherein the geographic control logic determines prohibiting the consumption of the content record based on the current location being outside the geographic area.
